(19) United States
(12) Patent Application Publication
(10) Pub. No.: US 2005/0012457 A1
(43) Pub. Date: Jan. 20, 2005

(54) Light-emitting semiconductor device packaged with light-emitting diode and current-driving integrated circuit

(75) Inventor: Chung Yu Wu, Hsin-Chu (TW)

Correspondence Address: BACON & THOMAS, PLLC, 625 SLATERS LANE, FOURTH FLOOR, ALEXANDRIA, VA, 22314, US

(73) Assignee: Macroblock, Inc., MACR, Hsin-Chu (TW)

(21) Appl. No.: 10/651,987

(22) Filed: Sep. 2, 2003

(30) Foreign Application Priority Data
Jul. 15, 2003 (TW) 092119195

(51) Int. Cl. H01J 1/62

(52) U.S. Cl. 313/512

(57) ABSTRACT

The present invention discloses a device for generating combining light of desired colors. This device includes at least three light emitting diodes and a current-driving integrated circuit chip encapsuled integrally. The driver chip provides constant current outputs to light emitting diodes of different colors, which are preset based on respective characteristics thereof. As a result, the current input and brightness of each light emitting diode is adjustable and thus combining light of expected color is generated, such as white light of color temperature 6,500˜8,000° K.

### BACKGROUND OF THE INVENTION

1. Field of the Invention

The present invention relates to a light-emitting semiconductor device packaged with light-emitting diodes and a current-driving integrated circuit (IC), which is particularly suitable for being applied to back light sources of liquid crystal displays and illumination of variable colors.

2. Related Prior Art

White light generated by light emitting diodes (LEDs) is an important development in application of semmiconductors. The major technologies include exciting phosphor with a blue LED and combining different color LEDs.

U.S. Pat. No. 6,069,440 discloses a light emitting device, in which a phosphor is provided to absorb a part of light emitted from a blue LED and emits light of wavelength different from that of the absorbed light. However, the color gamut formed by such device is inadequate, and therefore some colors can not be reflected from objects of the same colors. Decay of the phosphur material is another serious problem, which will lower brightness of the emitted light and generate in bluish or greenish light.

U.S. Pat. No. 6,448,550 B1 discloses a solid state illumination device for producing a predetermined spectral distribution. Though the above problems can be solved by combining light of different colors, deviation of LED forward voltage doesn't faciliate mass production. Further, LEDs of different colors may present different brightness even the same forward current is provided. Therefore, it's necessary to meliorate these problems by providing a device suitable for mass production.

### SUMMARY OF THE INVENTION

The object of the present invention is to provide a light-emitting semiconductor device packaged with light-emitting diodes and a current-driving integrated circuit (IC), which exhibits a combining light with adequate color gamut and good stability, and is suitable for mass production.

In order to achieve the above object, the light-emitting semiconductor device primarily includes at least two terminals, at least three LED dice of red, green and blue colors, a driver IC chip, an insulating substrate, and a refractive encapsulation material.

Each of the LED dice includes two electrode contacts, one of which is connected to a common node by an electrically conductive means. This common node is further connected to one of the terminals of the light-emitting semiconductor device. The driver IC chip also includes a contact connected to another terminal of the light-emitting semiconductor device and provides at least three output ports.

Both of the LED dice and the driver IC chip are attached on the insulating substrate and integrally encapsulated with the refractive encapsulation material. The encapsulation material also refracts the light beams emitted from the LED dice toward predetermined directions. The LED dice and the driver IC chip are connected to each other by an electrically conductive means. In general, one of the electrode contacts of each LED die is connected to the respective output port of the driver IC chip.

Accordingly, the light-emitting semiconductor device can be lit by applying voltage or current on the terminals thereof, and thus generate a combining light.

The light-emitting semiconductor device of the present invention can be further attached to an application board by adhering the terminals thereon with surface mount technology.

The current of each output port of the driver IC chip can be preset for adjusting brightness of the corresponding LED and obtaining a predetermined ratio thereof. Different ratios of the emitted light may result in combining light of different colors. For example, white light of color temperature 6,500˜8,000° K can be obtained when presetting the current input of red, green and blue LEDs at a ratio of (0.8˜1.2):(0.8˜1.2):(0.8˜1.2).

Moreover, regardless of deviation of the forward voltage, the driver IC chip of the present invention can provide constant currents for LEDs.

In addition to the terminals and contact aforementioned, the light-emitting semiconductor device and the driver IC chip may further respectively include a third terminal and another contact, which are connected to each other by an electrically conductive means. Therefore, the current of the outputs of the driver IC chip can be specifically controlled by applying current or voltage to the third terminal.

### BRIEF DESCRIPTION OF THE DRAWINGS

FIGS. 1 and 2 are a cross section and a perspective view of the light-emitting semiconductor device in accordance with the present invention.

FIGS. 3-6 show electrical connection of four preferred embodiments in accordance with the present invention.

FIGS. 7 and 8 are block diagrams of the circuits in FIGS. 5 and 6.

### DETAILED DESCRIPTION OF THE PREFERRED EMBODIMENTS

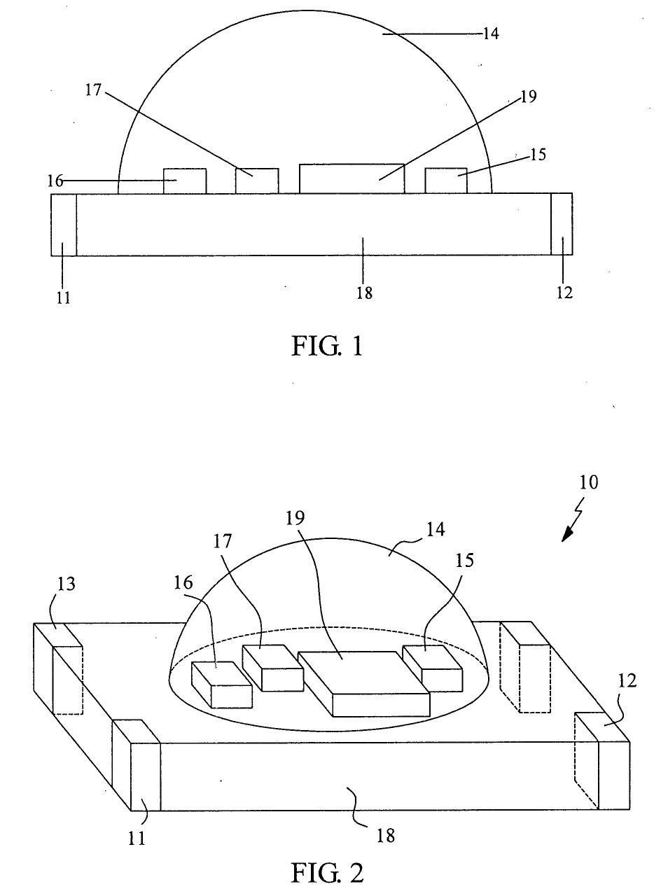

FIGS. 1 and 2 are a cross section and a perspective view of a light-emitting semiconductor device 10 in accordance with the present invention. As shown in FIGS. 1 and 2, the light-emitting device 10 includes three LED dice 15, 16 and 17 of red, green and blue colors, refractive encapsulation material 14, an insulating substrate 18 and a current-driving IC chip 19.

The LED dice 15, 16 and 17 and the current-driving IC chip 19 are attached to the insulating substrate 18 on which required electrically conductive means is arranged as a printed circuit board (PCB). The light-emitting device 10 can be further attached on an application board (not shown in the drawings) by adhering a first terminal 11 and a second terminal 12 thereon with surface mount technology.

The present invention is primarily characterized by packaging the LED dice 15, 16 and 17 and the current-driving IC chip 19 integrally in the encapsulation material 14. The encapsulation material 14 can refract light beams emitted from the LED dice 15, 16 and 17 toward a predetermined direction.

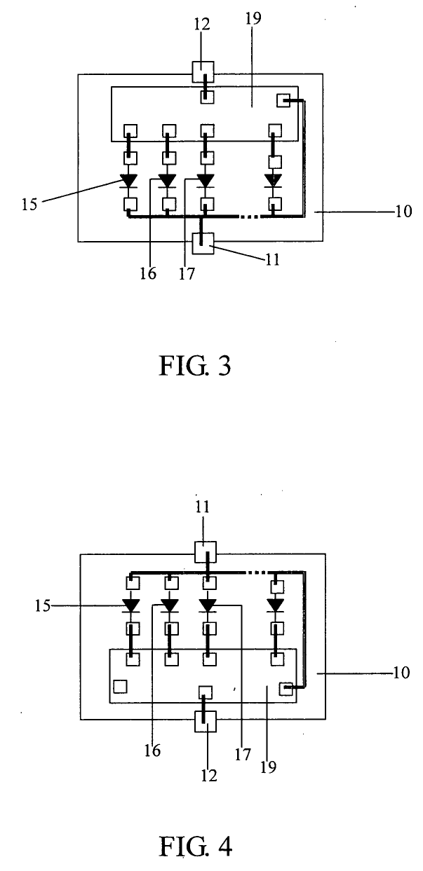

Refer to FIGS. 3 and 4, which show electrical connection of the first and the second embodiments in accordance with the present invention. Each one of the LED dice 15, 16, 17 . . . includes two electrode contacts, one of which is connected to a common node and further to the first terminal 11 of the light-emitting device 10 by means of PCB and wire bonding. The contact of the current-driving IC chip 19 is connected to the second terminal 12.

Another electrode contact of each LED die is connected to a respective current output port of the current-driving IC chip 19. The current outputs of the current-driving IC chip 19 are constant and can be preset based on characteristics of each LED, even though deviation of forward voltage exists. Accordingly, the current input and brightness for each LED die can be adjusted to obtain combining light of desired color, for example, white light of color temperature 6,500˜8,000° K.

In the present invention, the LEDs are not restricted to red, green and blue colors, but one or more LEDs of others colors can be included.

As shown in FIG. 3, the first embodiment presents a co-cathode circuit, as the cathode contacts of the LED dice 15, 16, 17 . . . are all connected to the common node by means of PCB and wire-bonding. This common node is further connected to the first terminal 11 of the light-emitting device 10.

Another feature of the first embodiment is that the anode contacts of the LED dice 15, 16, 17 . . . are connected to their respective current output port of the current-driving IC chip 19, whereby the LEDs are respectively lit when a voltage or current is offered.

A further feature of this embodiment is that the contact of the current-driving IC chip 19 is connected to the second terminal 12 of the light-emitting device 10 by means of PCB and wire-bonding.

FIG. 4 shows the second embodiment with a co-anode circuit, as the anode contacts the LED dice 15, 16, 17 . . . are all connected to the common node by means of PCB and wire-bonding. This common node is further connected to the first terminal 11 of the light-emitting device 10.

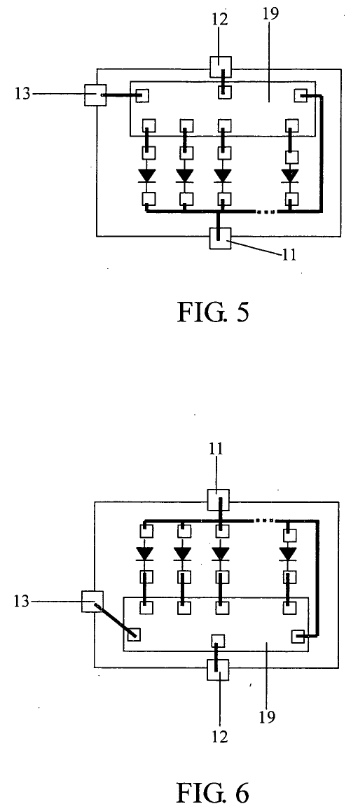

FIG. 5 shows another co-cathode circuit, which is different from the first embodiment by increasing a third terminal 13 on the light-emitting device 10. The terminal 13 is connected to an additional contact of the current-driving IC chip 19 by means of PCB and wire-bonding. The terminal 13 principally provides a voltage or current for controlling the current outputs of the current-driving IC chip 19, which will vary brightness of the LEDs.

FIG. 6 shows another co-anode circuit, which is different from the second embodiment by increasing a third terminal 13 on the light-emitting device 10. The terminal 13 is connected to an additional contact of the current-driving IC chip 19 by means of PCB and wire-bonding. The terminal 13 principally provides a voltage or current for controlling the current outputs of the current-driving IC chip 19, which will vary brightness of the LEDs.

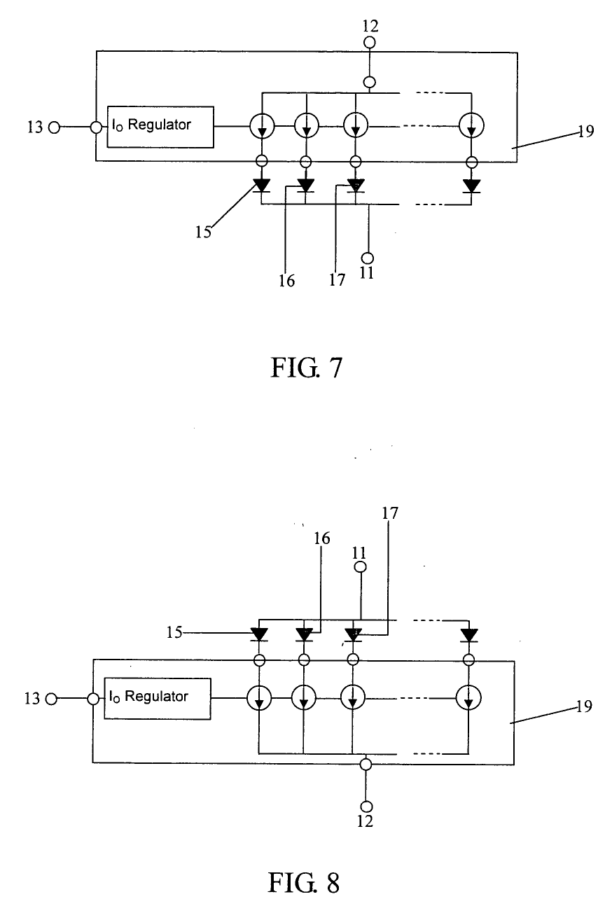

FIGS. 7 and 8 are block diagrams of the circuits respectively shown in FIGS. 5 and 6. The output ports of the current-driving IC chip 19 are correspondingly connected to the anodes (cathodes) of the LED dice 15, 16, 17 . . . so as to drive the respective LED.

In the present invention, brightness of each LED can be adjusted by presetting the respective current output of the current-driving IC chip 19. Combining light from the LEDs with proper brightness will generate light of specific color. For example, by setting current inputs of the red, green and blue LEDs at the ratio of (0.8˜1.2):(0.8˜1.2):(0.8˜1.2), white light of color temperature 6,500˜8,000° K will be generated.

In accordance with the present invention, the intellectual current-driving IC provides a constant and presset current to precisely control the brightness of each LED. In other words, disadvantages of the prior technologies, such as insufficiency of color gamut, can be improved and the problem of deviation of LED's forward voltage can be set aside so as to faciliate mass production. Moreover, the driver IC is sized small enough to be packaged with surface mount technology (SMT) and pin-through-hole technology (PTH), both single inline package (SIP) and dual inline package (DIP).

1. A light-emitting semiconductor device, comprising:
at least two terminals;
a plurality of LED dice of at least red, green and blue colors, and each of said LED dice comprising two electrode contacts;
a driver IC chip comprising a contact and at least three output ports;
an insulating substrate attached beneath said LED dice and said driver IC chip; and
a refractive encapsulation material for integrally encapsulating said LED dice and said driver IC chip, and refracting light emitted from said LED dice toward a predetermined direction;
wherein:
one of said electrode contacts of each LED die is connected to a common node by an electrically conducting means, and said common node is further connected to one of said terminals of said light-emitting semiconductor device;
said contact of said driver IC chip is connected to another terminal of said light-emitting semiconductor device;
said LED dice are lit by applying voltage or current to said terminals of said light-emitting semiconductor device; and
said light-emitting semiconductor device is attached on an application circuit board by adhering said terminals thereon with surface mount technology.

2. A light-emitting semiconductor device, comprising:
at least two terminals;
a plurality of LED dice of at least red, green and blue colors, and each of said LED dice comprising two electrode contacts;
a driver IC chip comprising a contact and at least three output ports;
an insulating substrate attached beneath said LED dice and said driver IC chip; and
a refractive encapsulation material for integrally encapsulating said LED dice and said driver IC chip, and refracting light emitted from said LED dice toward a predetermined direction;
wherein:
one of said electrode contacts of each LED die is connected to a respective output port of said driver IC chip by an electrically conducting means;
another electrode contact of each LED die is connected to a common node by an electrically conducting means, and said common node is further connected to one of said terminals of said light-emitting semiconductor device;
said contact of said driver IC chip is connected to another terminal of said light-emitting semiconductor device; and
said LED dice are lit by applying voltage or current to said terminals of said light-emitting semiconductor device.

3. A light-emitting semiconductor device, comprising:
at least two terminals;
a plurality of LED dice of at least red, green and blue colors, and each of said LED dice comprising two electrode contacts;
a driver IC chip comprising a contact and at least three output ports;
an insulating substrate attached beneath said LED dice and said driver IC chip; and
a refractive encapsulation material for integrally encapsulating said LED dice and said driver IC chip, and refracting light emitted from said LED dice toward a predetermined direction;
wherein:
one of said electrode contacts of each LED die is connected to a respective output port of said driver IC chip by an electrically conducting means;
another electrode contact of each LED die is connected to a common node by an electrically conducting means, and said common node is further connected to one of said terminals of said light-emitting semiconductor device;
said contact of said driver IC chip is connected to another terminal of said light-emitting semiconductor device;
said LED dice are lit by applying voltage or current to said terminals of said light-emitting semiconductor device; and
brightness of each LED die is adjusted by setting output of the respective output port of said driver IC chip, whereby a combining light of desired color is generated.

4. A light-emitting semiconductor device, comprising:
at least two terminals;
a plurality of LED dice of at least red, green and blue colors, and each of said LED dice comprising two electrode contacts;
a driver IC chip comprising a contact and at least three output ports, and providing a constant current unaffected by deviation of forward voltages of said LED dice;
an insulating substrate attached beneath said LED dice and said driver IC chip; and
a refractive encapsulation material for integrally encapsulating said LED dice and said driver IC chip, and refracting light emitted from said LED dice toward a predetermined direction;
wherein:
one of said electrode contacts of each LED die is connected to a respective output port of said driver IC chip by an electrically conducting means;
another electrode contact of each LED die is connected to a common node by an electrically conducting means, and said common node is further connected to one of said terminals of said light-emitting semiconductor device;
said contact of said driver IC chip is connected to another terminal of said light-emitting semiconductor device; and
said LED dice are lit by applying voltage or current to said terminals of said light-emitting semiconductor device.

5. A light-emitting semiconductor device, comprising:
at least three terminals;
a plurality of LED dice in of at least red, green and blue colors, and each of said LED dice comprising two electrode contacts;
a driver IC chip comprising at least two contacts and at least three output ports;
an insulating substrate attached beneath said LED dice and said driver IC chip; and
a refractive encapsulation material for integrally encapsulating said LED dice and said driver IC chip, and refracting light emitted from said LED dice toward a predetermined direction;
wherein:
one of said electrode contacts of each LED die is connected to a respective output port of said driver IC chip by an electrically conducting means;
another electrode contact of each LED die is connected to a common node by an electrically conducting means, and said common node is further connected to one of said terminals of said light-emitting semiconductor device;
two contacts of said driver IC chip are respectively connected to another two terminals of said light-emitting semiconductor device, and one of said terminals provides a voltage or current for controlling outputs of said driver IC chip; and
said LED dice are lit by applying voltage or current to said terminals of said light-emitting semiconductor device.

6. The light-emitting semiconductor device as claimed in claim 3, wherein said combining light is white light of color temperature 6,500˜8,000° K.

7. The light-emitting semiconductor device as claimed in claim 6, wherein said outputs of the output ports of said driver IC chip are preset at a ratio of red:green:blue=(0.8˜1.2):(0.8˜1.2):(0.8˜1.2).

8. The light-emitting semiconductor device as claimed in claim 5, wherein said outputs of said driver IC chip controlled by one of said terminals vary brightness of said LED dice and thus generate a combining light of desired color.

9. The light-emitting semiconductor device as claimed in claim 8, wherein said combining light is white light of color temperature 6,500˜8,000° K.
